(19) United States
(12) Patent Application Publication
(10) Pub. No.: US 2009/0129294 A1
(43) Pub. Date: May 21, 2009

(54) Systems and methods for multi-customer access to high speed data optimization applications over TCP/IP WAN and internet

(76) Inventor: Terry D. Mikkelson, Dellwood, MN (US)

Correspondence Address: Dale Freeman, 2577 Crooked Vine Ct., Colorado Spring, CO, 80921, US

(21) Appl. No.: 12/313,488

(22) Filed: Nov. 20, 2008

Related U.S. Application Data
(60) Provisional application No. 61/003,778, filed on Nov. 20, 2007.

(51) Int. Cl. H04L 12/16; H04L 12/28

(52) U.S. Cl. 370/259; 370/422

(57) ABSTRACT

The present invention allows multi-customer access to the common high speed carrier for contracting customers. The customer initiates a data transfer utilizing a registered address that activates high speed encapsulation to accelerate the data transmission. This change allows multiple users, who share the same local environment to access the infrastructure under contract. Central office routers will identify incoming customer's addresses and then provide specific, pre-defined services based upon the addressee of the data. The invention also incorporates a customer billing process and the ability for customizing the service to each subscriber

### CROSS-REFERENCE TO RELATED APPLICATIONS

This application claims the benefit of provisional patent application Ser. No. 61/003,778, filed 2007 Nov. 20 by the present inventor.

### FEDERALLY SPONSORED RESEARCH

Not Applicable

### SEQUENCE LISTING OR PROGRAM

Not Applicable

### BACKGROUND

This invention relates to providing multiple customer access to WAN optimization equipment and services. Currently, WAN optimization equipment, such as HyperIP™, is limited to single customers who buy or lease the equipment for their own enterprise. The invention enables the commercialization of this service to multiple customers using innovations in architecture and equipment. Included in the innovations of this multi-customer “Accelerator Company” are addressing and receipt protocols along with contracting and billing methods and systems.

### BRIEF SUMMARY OF THE INVENTION

The problems of providing multi-customer, commercial access to WAN optimization hubs are solved by equipment and architecture that allows the use of this data transfer capability to multiple users. This WAN optimization capability, including HyperIP™, can be provided to customers in customized packages, that may include options to encrypt and or compress data based upon the customers direction, as identified by the incoming and destination address of the customer. The WAN optimization capability allows the stable transfer of data across long distances without the latency and lost packets usual with traditional data transfer over the internet.

Central office routers will identify incoming customer's addresses and then provide specific, pre-defined services based upon the addressee of the data. The invention also incorporates a customer billing process and the ability for customizing the service to each subscriber.

### BRIEF DESCRIPTION OF THE DRAWINGS

FIG. 1 is a general schematic diagram showing the overall network for commercialization of network optimization technology using the Accelerator Company's Central Office hubs.

FIG. 2 is a flow diagram of how customer data is transferred to the WAN optimization appliance provided by the Accelerator Company.

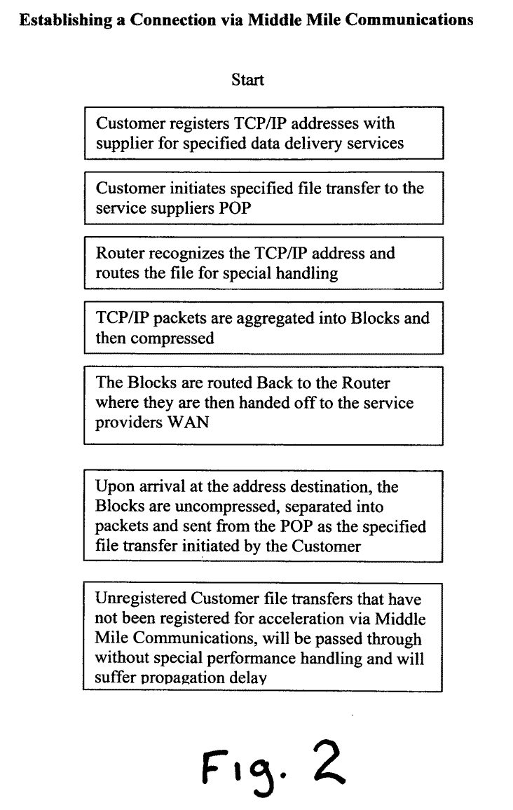

### DETAILED DESCRIPTION

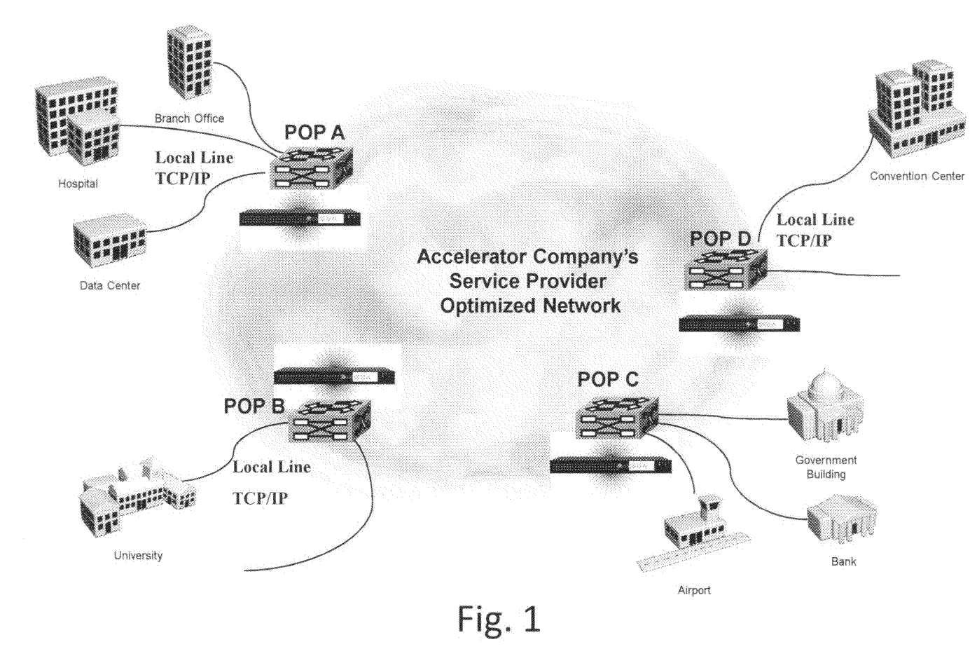

There are various embodiments and configurations for implementing multi-customer access to optimized WAN acceleration and stabilization services. One such embodiment is shown in FIG. 1, where customers communicate with others customers or their subsidiaries by sending the traffic to the closest Central Office (CO). At the CO the data is encapsulated for WAN optimization transmission and sent to the CO closest to the addressee. Using this method, a customer contracts with the Accelerator Company to access a high performance secure communications environment on request. This customer having been previously be identified and have established a contract with the Accelerator Company for the service.

Specific services and transmission requirements are defined and delivered at the Central Office. Many customers may use the services under contract. Service options are customized to each purchaser and may include, but not limited to:

Data Rate;

Distance;

Transmission Time;

Compression;

Encryption.

Others services will be provided as defined by the customer's requirement and may be further refined to specific services to each addressee for the data. The Accelerator Company provides customers access to optimized, non dedicated circuits.

Virtual access can be supplied to the infrastructure, so multiple users may be using the infrastructure simultaneously. The number of users will be dictated by the capacity of the communications circuit and the aggregate capacities of those involved. The service will not allow over subscriptions.

An independent connection is maintained over the WAN between the Accelerator Company's appliance. The flow of data from the application is governed by the generation of TCP acknowledgements from the local Accelerator Company's CO to the local application server or storage controller. These acknowledgements keep the TCP windows open, so data can continue to be sent by the application. The Accelerator Company shields the application's TCP connections from performance variations due to packet loss and latency on the WAN, since the performance over the WAN is managed by the Accelerator Company.

1. A system for establishing a multi-customer accelerated digital data transfer connections comprising:
means for receiving user sent digital signal together with identification sequence for sender and recipients, into the accelerator company's central office;
means for recognizing that the digital signal is to be routed to the accelerator company's central office in a city closest to each recipient; and
means for routing the digital data signal from the accelerator company's receiving central office to the local recipient.

2. The system of claim 1, further comprising means for billing each customer according to services requested, including, but not limited to, transmission size, encryption, and time of day of transmission.

3. A method to establish a multi-customer accelerated digital data transfer connections comprising:
receiving a registered customer's TCP/IP address;
recognizing specific action said customer has contracted for based upon addressee;
customer initiates specified file transfer to accelerator company's POP;
TCP/IP packets are aggregated into blocks and compressed;
these blocks are sent via WAN optimization transfer to accelerator company's central office nearest addressee;
the blocks are uncompressed, separated into packets and sent from the POP as the specified file transfer initiated by the customer.
